(19) United States
(12) Patent Application Publication
(10) Pub. No.: US 2012/0030039 A1
(43) Pub. Date: Feb. 2, 2012

(54) METHODS OF ESTABLISHING SIP COMMUNICATIONS BY THE ACTIVATION OF A LINK ON A WEBSITE

(75) Inventor: Álvaro Fernández Gutiérrez, Barcelona (ES)

(73) Assignee: Media Patents, S.L., Barcelona (ES)

(21) Appl. No.: 13/248,340

(22) Filed: Sep. 29, 2011

Related U.S. Application Data
(63) Continuation of application No. PCT/ES2010/070180, filed on Mar. 25, 2010.

(30) Foreign Application Priority Data
Mar. 31, 2009 (ES) P200900874

(51) Int. Cl. G06Q 30/02

(52) U.S. Cl. 705/14.73

(57) ABSTRACT

Methods of establishing an SIP communication between a first network device and a second network device is provided. According to one implementation the first network device includes a web browser and a first IP telephone and the second network device includes a second IP telephone. In one implementation an advertising link on a webpage includes identifying information of the advertising link, identifying information of the website hosting the advertising link and information containing a SIP URI associated with the second IP telephone, and upon the advertising link being activated by the browser the first network device establishes an SIP communication between the first IP telephone and the second IP telephone using the SIP URI of the second IP telephone.

### CROSS-REFERENCE TO RELATED APPLICATIONS

This application relates to and claims benefit and priority to International Application PCT/ES2010/070180, filed Mar. 25, 2010, which relates to and claims the benefit and priority to Spanish Patent Application No. P200900874, filed Mar. 31, 2009.

### TECHNICAL FIELD

The invention is comprised in the field of Internet communications.

### BACKGROUND

Companies selling products or services advertised on the Internet try to ensure that users who view their website or their Internet advertisements contact the company to make a purchase of products or services.

A known method for attracting online visitors consists of advertising the products on websites with content that attracts users interested in a specific term. These content websites may be, for example, thematic pages on video games, movies, music, computer programs, etc. The advertisements are available as a link pointing to the selling company's web page, such that when a user clicks on one of the links he or she is redirected to the web page of the selling company and the latter pays a remuneration to the content website in relation to the number of clicks made on the links. For this method to be effective it is necessary to establish contact between selling companies and web pages, and organize technically the way they include link-advertisements and the way that they reward for the clicks made. One existing system that solves this requirement is Google's “AdSense” system which is described in U.S. patent applications published as US2004/0093327 and US2004/0059708, and in U.S. Pat. No. 5,948,061. This system enables any website to include advertising from several advertisers and to receive a remuneration for it. The advertisers using this system can advertise on web pages belonging to the “search engine network” or to the “content network” of the Google search engine. The “search engine network” comprises Web pages where the Google search dialog box appears, in which a search can be conducted in the same way as on the Google search engine web page. When the search is conducted, normal or “organic” results, and also some advertisements as “sponsored links” form appear. The “content network” comprises websites displaying advertisements for advertisers whose products are related to the content. The “AdSense” system analyses the content of websites seeking to host advertisements and decides which are the most appropriate for each advertisement. The advertisements contain a link to the advertiser's web page. Each time that a user clicks on one of these linked ads, the web page owner hosting the ad receives remuneration from the advertiser.

FIG. 1, extracted from U.S. Pat. No. 5,948,061, shows an example of a content network 10 of the prior state-of-the-art, wherein all the communications between the various network nodes are implemented through http protocol 14.

A browser 16 accesses a web page of the affiliated website 12 using http protocols. To this end, the browser sends an http message 20 request-type to the affiliated website 12 and receives one or several http response messages 22 with the content of the requested web page.

When browser 16 uploads the web page from the affiliated website 12, the advertising server 19 inserts an advertisement into the web page. To this end, may use for example, an HTML language <img> tag that inserts images stored on another Web server into the web page. The browser sends a request message 23 to the server 19 to request the image indicated in the <img> tag and the server transmits the image through reply 24.

When the user of browser 16 activates the image link containing an advertisement, browser 16 reconnects with server 19 that transmits the URL information of an advertiser's website 18. Then, the browser requests the web page of the advertising website through an http message 26, and the advertising site transmits the web page through the reply 28.

The affiliated website 12 owner receives compensation each time that an advertisement is displayed or every time that an advertisement is activated from the user's browser. Through the system described in U.S. Pat. No. 5,948,061, the owner of a content website 12 that receives numerous visits can profit from the visits to its website through an agreement with an advertisement server 19.

Usually, the objective of the algorithms of the AdSense-type systems managing advertising campaigns is to maximise the search engine income, which causes a problem for the owners of the content web pages, who do not have the negotiating power versus large Internet companies, such as for example the Internet search engines, and consequently they receive a reduced remuneration for each advertisement displayed on their web page, or for each advertisement activated on their web page.

In these systems the advertiser placing the advertisement does not know the price that the intermediary is paying to the website where the content is inserted and, likewise, the content website does not know how much the advertiser is paying to the intermediary for each click or every time that the advertisement is displayed. Thus, for example, it could arise that the advertiser pays $1 for each click and the owner of the content website only receives $0.01 for each click.

An alternative system for profiting from content websites is the sales commission based system. In this system, websites known as affiliated or associated sites, charge a commission on the sales generated by their clicks. U.S. Pat. Nos. 5,991,740 and 6,029,141 describe two systems of this type. In these systems the affiliated site charges a commission for the sales generated by each click on a link that directs the user from the web page of the affiliated site to a virtual store where the purchase is made.

FIG. 2 shows this type of commission based system. Specifically, it shows an online advertising system in which a device 252 uses a communication 201 to communicate with an affiliated web site 220 through the HTTP (Hypertext Transfer Protocol). Normally, to this end the http protocol uses several TCP/IP connections via Internet that are not shown in the figure in order to simplify. Device 252 may be a computer, a PDA, a mobile phone with a web browser or any other device enabling the use of a web browser. Affiliated website 220 is a website that displays advertising links and that can display content to attract visitors.

Likewise, line 202 represents the communication which occurs through the http protocol between computer 252 and an intermediary system 280.

Communication 203 represents the communication through the http protocol between computer 252 and a selling website 232.

A website is generally composed of several devices connected to the Internet, including a web page server. Intermediary system 280 also is comprised by a set of devices connected to the Internet which may also provide a web page server.

Content website 220 contains a web page 223 with two advertisements or links 221 and 222. When browser 251 accesses web page 223 and one of the links 221, 222 is activated, the browser uses the HTTP protocol to access to the URL web page associated with the link and displays the new web page. In this way the user can browse between different web pages, by clicking on different links, each of which has an associated URL.

Link 222 has an associated URL that points to a web page of a virtual store 231 of selling website 232 where the user using computer 252 can make an online purchase.

In the current state-of-the-art, website 232 can detect, through various systems, which is the related website 220 that directed the user to the virtual store, and follow up the user's transaction on transactional website 232 to remunerate the affiliated website 220.

Several systems used in the current state-of-the-art for transmitting to the selling website 232 information 229 that identifies which affiliated website 220 has generated the visit, are explained below.

As no direct TCP/IP connection is established between affiliated website 220 and selling website 232, an indirect mechanism is needed to send to website 232 the information 229 identifying website 220. The various systems or mechanisms of the current state-of-the-art utilise different HTTP protocol properties to transmit the information 229 to website 232.

A first system is to transmit the information 229 as a parameter of link 222 URL that directs the user from website 220 to website 232. URL 204, which contains information 229, is sent from website 220 to browser 251 of computer 252 and the browser 251 transmits the URL 204 together with the information 229 to website 232 using the HTTP protocol to access to the website 232. This system is described in U.S. Pat. No. 6,029,141 and does not involve the use of an intermediary system 280.

Optionally, information 229 can also identify which is the advertisement or link which the user has clicked on. In this way, if a user clicks on the advertisement for a certain product, website 232 receives the information identifying the product and can directly display the information about the product to the user when he or she accesses its website, thereby obviating the need for the user to browse on selling website 232 to locate that information.

A second system is to use an intermediary system 280 that serves as an intermediary between advertising website 220 and selling website 232. When the user clicks on link 221 he or she is directed to intermediary website 280 and from there is redirected to selling website 232. Before redirecting the user, the intermediary system stores information 229 in a cookie 205 and sends the cookie 205 to the user's computer. Virtual store 231 contains a final web page, which the user accesses when he or she completes the online purchase or transaction. The web page includes a link to element 289 from the web server of intermediary site 280. This element may be, for example, an image, a text or even an invisible image. When the user's browser 251 uses the HTTP protocol to read the final page, it has to access the intermediary site through the http protocol to obtain element 289 and at that time cookie 205 is sent with information 229 to the web server of the intermediary site. This system is described in U.S. Pat. No. 5,991,740.

### SUMMARY OF THE DISCLOSURE

According to one implementation a system is provided making possible to establish communications using voice over IP protocols when links from a web page of an affiliated website are activated, so that the affiliated website can receive compensation when links on this website are activated.

According to one implementation a procedure is provided for establishing a communication using the SIP (Session Initiation Protocol) in a data network comprising:
a first network node that provides a browser program or Internet browser program and a first SIP User Agent, and;
a second network node containing an affiliated website including content and a link that are displayed on the browser of the first network node, and;
a third network node containing a Control Server that provides information about the said link that is displayed on the browser, and;
a fourth network node containing a second SIP User Agent, and;
a fifth network node containing a SIP Proxy that can channel the SIP messages exchanged by the first SIP User Agent and the second SIP User Agent, and;
upon activating the link in the browse of the first network node, the first SIP User Agent sends, through the SIP Proxy an “INVITE”-type SIP message to the second SIP User Agent to establish a SIP communication with the second SIP User Agent, and;
the SIP message contains identifying data associated with the link and the affiliated website, and;
the SIP Proxy receives the SIP message and transmits the identifying data to the third network node, and;
the SIP Proxy retransmits the INVITE-type SIP message to the second SIP User Agent.

In one implementation, SIP Proxy transmits the second identifying data to Control Server using messages employing the SIP protocol.

In one implementation the SIP Proxy includes a line in the SIP messages that it transmits to the second SIP User Agent, so that all subsequent SIP messages compulsorily pass through the SIP Proxy.

In one implementation the SIP Proxy uses “ACK” and “BYE” messages to measure the SIP communication time established upon activating the link.

In one implementation SIP Proxy or Control Server detects fraudulent clicks based on the timeframe of the communication.

In one implementation the SIP Proxy stores information about devices that have generated fraudulent clicks, and filters the subsequent SIP communications that include the information that was previously included in a SIP message generated through a fraudulent click. In one implementation, the information is the IP address of the device which generated the fraudulent clicks.

In one implementation the SIP Proxy transmits the SIP messages to a SIP Gateway using a second protocol to establish communication with a telephone.

### BRIEF DESCRIPTION OF DRAWINGS

Other advantages and characteristics of the invention are shown in the following description which includes some preferred, and non-limiting, embodiments of the invention.

FIG. 1 shows an example of a prior art advertising on affiliated networks that use the http protocol.

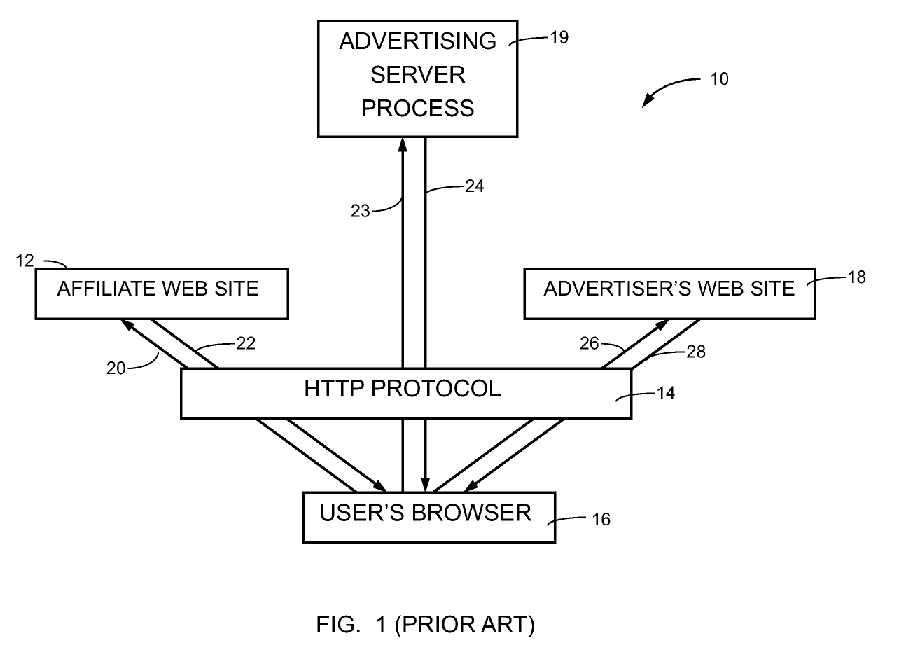

FIG. 2 shows several examples of prior art link-tracking systems activated on affiliated websites.

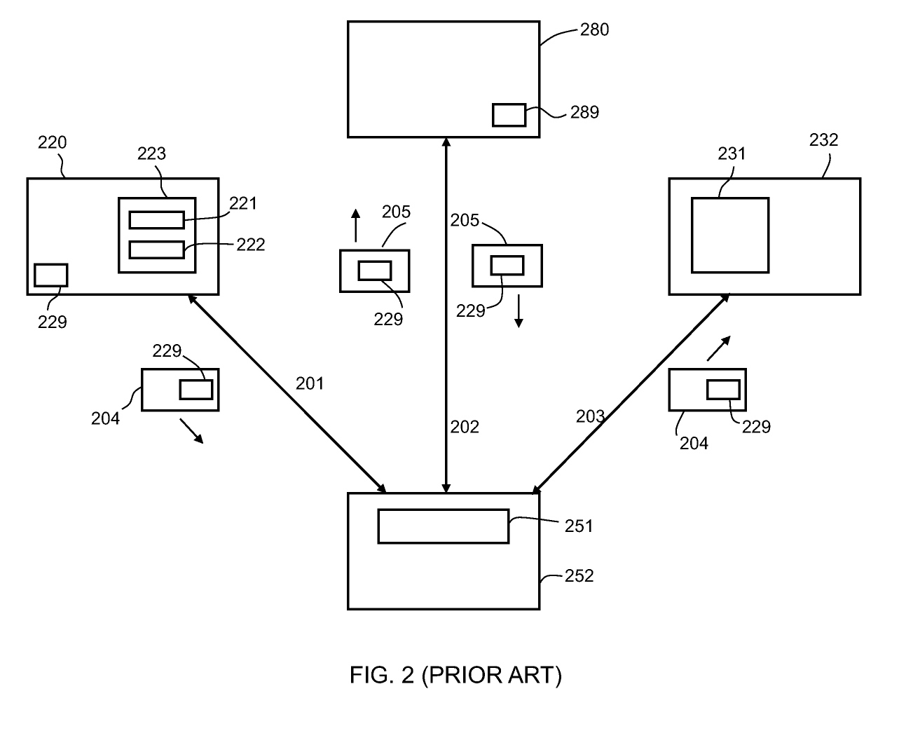

FIG. 3 shows an example of a message flow used to establish a SIP communication through a SIP Proxy.

FIG. 4 shows a typical configuration of communications between two SIP Proxies generally known as a “SIP trapezoid.”

FIG. 5 shows a data network that contains different network nodes according to one implementation.

FIG. 6 shows a data network according to one implementation that contains various network nodes, between them two SIP Proxies.

FIG. 7 shows an implementation using a SIP Proxy belonging to a different domain.

FIG. 8 shows an implementation in which the two SIP User Agents can establish SIP communications without the need to use SIP Proxies.

FIG. 9 shows an implementation where a SIP Gateway is used to establish communications with a conventional telephone.

### DETAILED DESCRIPTION

The systems for inserting links into the affiliated websites described in the prior art are based on the http protocol. These systems are not adequate for combining the http protocol together with another different protocol, such as for example, the SIP protocol (Session Initiation Protocol), in order to establish a telephone communication using the SIP protocol when a user activates a link of an affiliated website.

According to one implementation a system is provided for inserting links into affiliated websites that use http and SIP protocols in combination, such that the users who employ a browser to activate a link on a web page of an affiliated site establish a VoIP (Voice over IP) type communication directly with an IP telephone of the corresponding advertiser's link.

In this way, attending in personalised way through an IP telephone the information requests from users who activate the advertisement links, the effectiveness of the advertising links is increased.

The SIP protocol is described in the RFC 3261 specifications, J. Rosenberg et.al, June 2002, and is available at the Internet address http://www.ietf.org/rfc/rfc3261.txt.

Some characteristics of the SIP protocol are briefly explained below.

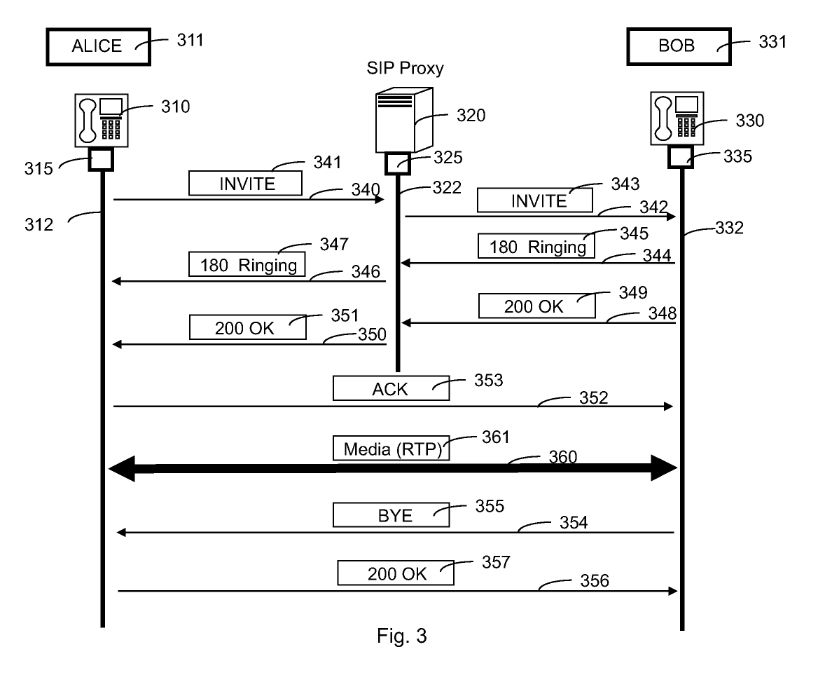

FIG. 3 shows a basic example of the establishment of a SIP session between two terminals 310 and 330 for VoIP communications through a SIP Proxy 320.

FIG. 3 shows two SIP telephones or terminals 310 and 330 corresponding to two fictitious users named Alice (311) and Bob (331). Terminals 310 and 330 include the functionalities of the protocol entities designated as “SIP User Agent Client” and “SIP User Agent Server”. For this reason, the terminals used by the users are called “SIP User Agents” in the SIP protocol.

Terminals or SIP User Agents 310 and 330 possess network interfaces represented by elements 315 and 335 respectively. The SIP Proxy server 320 possesses a network interface represented by element 325.

Terminals 310 and 330 together with SIP Proxy 320 exchange messages using the SIP and RTP protocols. These messages are encapsulated in IP packets.

The thick lines 312, 322 and 332 of FIG. 3 indicate the origin and the destination of each message and provide clarification of the temporary order of the interchanged messages, taking place in the descending order displayed between the lines.

The messages that use the SIP protocol are indicated through arrows 340, 342, 344, 346, 348, 350, 352, 354 and 356. The origin and destination of the IP packet that transports the SIP message are indicated through the direction of the arrow.

Thick line 360 represents the interchange of multimedia content between the two terminals using, for example, the RTP protocol. The multimedia content may, for example, be a telephone conversation between Alice and Bob.

FIG. 3 shows a characteristic of the SIP protocol. This characteristic is that the multimedia content of the communication represented in FIG. 3 by the thick line 360, which uses the RTP or “Real Time Protocol”, is transmitted directly between Alice's terminal 310 and Bob's terminal 330. In this way, the IP packets encapsulating multimedia content through the RTP protocol do not pass through SIP Proxy 320.

The establishment of the SIP session of FIG. 3 is explained in greater detail below. In FIG. 3 the SIP communication is established by using a SIP Proxy 320. However, the SIP protocol also allows two SIP User Agent to establish a SIP communication without requiring the use of a SIP Proxy.

In FIG. 3, Alice knows the IP address of the SIP Proxy 320 server used by Bob to establish SIP sessions, and sends 340 from her SIP terminal 310, an INVITE-type SIP message 341 to SIP Proxy 320. The SIP Proxy 320 resends the INVITE 343 message to BOB's SIP terminal 330 through the communication 342.

This SIP message 341, 343 of INVITE-type, includes a unique identifier for the SIP session through a SIP field or head called “Call-ID.” It also includes information about the method through which Alice wants to use to establish the SIP session with Bob. In order to describe the ways, the SIP protocol uses a second protocol called the “Session Description Protocol” (SDP) method.

The SDP protocol is described in specifications RFC 2327, M. Handley et. al., April 1998, edited on-line by the IETF and is currently available at the Internet address www.ietf.org/rfc/rfc2327.txt

Included inside the information that the INVITE type SIP message transmits through the SIP protocol, is the IP address of the network interface 315 of Alice's terminal 310 from which it will transmit the multimedia content, the type of protocol that it will use to transmit the multimedia information, for example RTP, and the port that it will use for the multimedia transmission.

When Bob's terminal 330 receives the INVITE 343 message it replies, sending through the communication 344, a “180 Ringing” 345 type SIP message to SIP Proxy 320 that resends message 347 by means of communication 346 to Alice's terminal 310. Simultaneously, Bob's terminal 330 issues a sound or some type of signal to indicate to Bob that a call is arriving.

When Bob decides to accept the call from Alice, for example by lifting the handset of terminal 330, Bob's terminal 330 sends through the communication 348, a “200 OK” type SIP message 349 to Alice's terminal through the SIP Proxy 330, which resends the “200 OK” message 351 to terminal 310 through the communication 350. This “200 OK” message includes a information, also described through the SDP protocol, through that Bob wishes to use to send the multimedia content, including the IP address and the port that the terminal 330 will use to send the multimedia content, and the type of protocol used to send the content, which, for example, may be the RTP protocol.

The last step for establishing the SIP session is that the Alice's terminal 310 sends through communication 352 an “ACK” 353 type SIP message to confirm to Bob that his response has been received. This message 353 is encapsulated in an IP packet that is sent directly from Alice's terminal to Bob's terminal without passing through SIP Proxy 320. For this purpose, Alice uses the IP address that Bob indicated through the SDP protocol in his “200 OK” message 349.

At this moment the SIP session is already established and terminals 310 and 330 can exchange multimedia content 361 using a protocol, such as for example, the RTP protocol. The multimedia communication, represented in the figure by thick line 360, takes place directly between Alice's terminal 310 and Bob's terminal 330 without passing through SIP Proxy 320.

The “BYE” 355 and “200 OK” 357 type SIP messages are used to finish the SIP session.

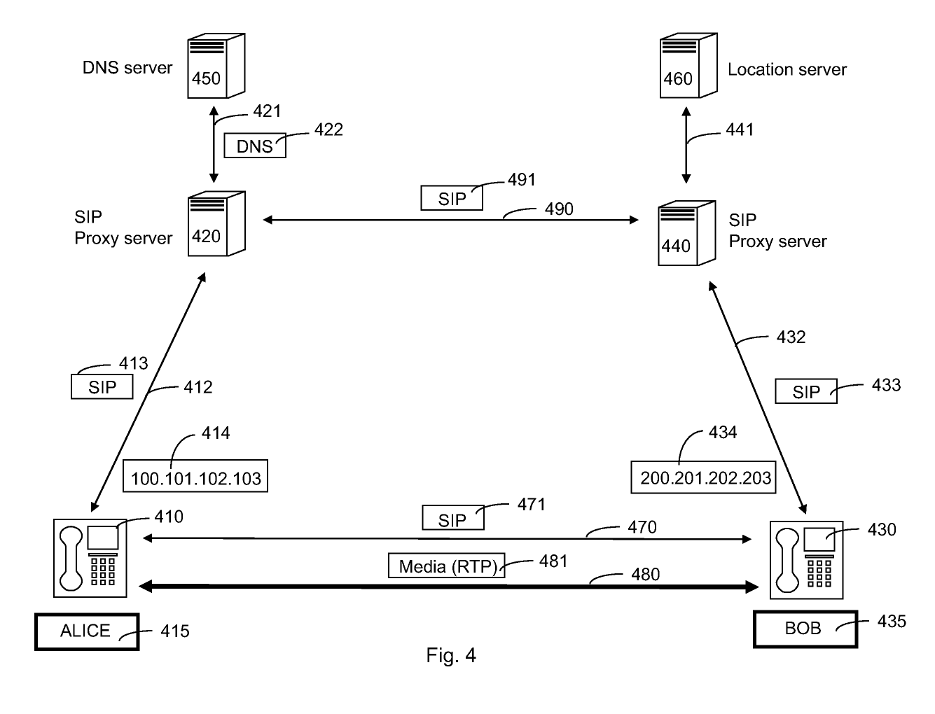

FIG. 4 shows a very common network topology called “SIP trapezoid.” In this topology, two SIP terminals 410 and 430 from different domains establish a SIP session using two SIP Proxy servers 420 and 440, one in each domain.

The term “SIP trapezoid” is used because of the trapezoid shape described by lines 470, 412, 490 and 432 that represent communications through the SIP protocol.

In the configuration of FIG. 4, each SIP terminal 410 and 430 is configured to use a SIP Proxy 420 and 440, respectively, to which it sends the SIP messages that transport requests for establishing SIP sessions.

For example, when the terminal 410 of Alice 415 wishes to establish a session with the terminal 430 of Bob 435, terminal 410 sends an INVITE type SIP message 413 to Proxy 420 through the communication 412. The steps that follow the INVITE message until it arrives at terminal 430 are explained below.

In keeping with the customary name used in RFC specifications of the IETF, the term “header” will be used to refer to the information that is transmitted through the SIP protocol text lines, and the term “field” to refer to the information that is transmitted through SDP protocol text lines.

The INVITE message sent by terminal 410 to proxy 420 includes a series of headers and fields with information, some of which is described below:
A header called “To” that includes a special URI (“Uniform Resource Identifier”) for the SIP protocol called SIP URI and that identifies the resource for which the INVITE message is intended. For example, the destination SIP URI of the INVITE message may be the URI sip:bob@mediapatents.com.
A header called “From” that includes a SIP URI that identifies the source resource that sends the SIP message, for example, sip:alice@example.com.
A SIP header called “Call-ID” that is a unique identifier for the SIP session to be established.
A series of fields using the SDP protocol. In the SDP fields is included the source IP address information that terminal 410 will use to send the multimedia data in the communication 480, as well as the port and the whished/wanted protocol type that will be used for the multimedia communication, for example the RTP protocol.

A URI or “Uniform Resource Identifier” is a compact character string that identifies a physical object or resource. The syntax for defining a URI is explained in specifications RFC 2396, Tim Berners-Lee et. al., August 1998, edited on-line by the IETF and currently available at the web address http://www.ietf.org(rfc/rfc2396.txt.

A SIP URI is a special type of URI that identifies a physical object or resource that uses the SIP protocol.

The SDP field used to indicate the IP address that will be used by terminal 410 in the multimedia communication 480 is the field called “connection” that begins with the letter “c.” In FIG. 4, the IP address of Alice's terminal is represented by element 414 of the figure that has the value 100.101.102.103. In this case, the INVITE message sent by Bob will contain the following line of text in the SDP protocol:

C=IN IP4 100.101.102.103

Where the parameter IN refers to the Internet network and parameter “IP4” indicates that the address which follows, 100.101.102.103 IP type version 4.

When SIP Proxy 420 receives the INVITE message addressed to the sip:bob@mediapatents.com resource, it uses the DNS protocol to locate the SIP Proxy Server of the “mediapatents.com” domain to which the message is addressed. To this end, SIP Proxy 420 communicates with DNS server 450 through the communication 421 using a message in the DNS protocol called “querie” of a special type called “DNS SRV” that uses the DNS protocol to locate the resources that provide services, in this case, SIP Proxy 440 of the “mediapatents.com” domain.

DNS server 450 responds by sending the SIP Proxy 440 IP address of “mediapatents.com” domain which Bob belongs. This exchange of messages in the DNS protocol in communication 421 is represented through element 422 of FIG. 4.

When SIP Proxy 420 receives the IP address of SIP Proxy 440, it transmits INVITE message 491 to Proxy 440 through communication 490. Normally, communication 490 uses a security protocol, such as for example the TLS protocol.

When Proxy 440 receives the INVITE message addressed to the resource indicated in the SIP URI “sip:bob@mediapatents.com”, Proxy 440 locates the resource and transmits the INVITE message to it. In FIG. 4, resource sip:bob@mediapatents.com is associated with terminal 430 and Proxy 440 sends the INVITE 433 type SIP message through communication 432 to terminal 430.

SIP Proxy 440 can use different location services to locate the sip:bob@mediapatents.com resource. The RFC 3261 specifications defining the SIP protocol, in Section “10 Registration” refer to this location service as an abstract service called “Location Service” that allows locating users within a certain associated domain, by associating the two types of URI explained below.

The SIP protocol defines the two SIP URI types. A first type of URI associated to users and a second type of associated to devices.

The SIP URI associated with users is called “Address-of-Record” URI (AOR URI). For example, user Bob may use the URI sip:bob@mediapatents.com and print this URI on his business cards. This URI would be the regular way of contacting user Bob and is normally included in the “To” and “From” headers of the SIP messages.

The SIP URIs associated with devices, also called “device URI” or “contact URI” allow addressing the SIP messages to the device used by each user at all times. For example, in FIG. 4, user Bob is using the terminal 430 associated with “contact URI” 200.201.202.203, which is IP address 434 used by terminal 430 to establish multimedia communications. Normally, the information about the URI associated with a device used by a user is included in the “Contact” header of the SIP messages.

Although there are many ways of providing the “Location Service”, the SIP protocol defines a special type of server called the “SIP register” that is responsible for linking the “Address-of Record URI” with one or several “device URIs,” storing this information in a database.

When a user changes devices he or she can send a “REGISTER” type SIP message to the server “SIP register” in order to associate his or her “AOR URI” with one or several “device URIs.”

In FIG. 4, when SIP Proxy 440 receives the INVITE message addressed to the URI sip:bob@mediapatents.com, Proxy 440 finds out the “device URI” through communication 441 with Location Server 460 that provides the “Location Server” services. The server transmits the information that the AOR URI sip:bob@mediapatents.com is associated with “device URI” 200.201.202.203 and Proxy 440 retransmits, through the communication 432, the INVITE message to the IP address of terminal 430, which is the IP address corresponding to the device URI. In this way, the INVITE message arrives at terminal 430, which user Bob is using at that time.

The SIP message flow for establishing the SIP session continues in the manner previously explained in FIG. 3, such that terminals 410 and 430 exchange new SIP messages 471 directly through the communication 470, until the SIP session is established and the start of multimedia communication 480 that exchanges multimedia content 481 directly between IP addresses 414 (100.101.102.103) of terminal 410 and IP address 434 (200.201.202.203) of terminal 430.

In the example of FIG. 4 the SIP Proxy Server and the Location Server are shown as separate servers. However, RFC 3261 define these servers as logical entities that can be executed on one or more servers.

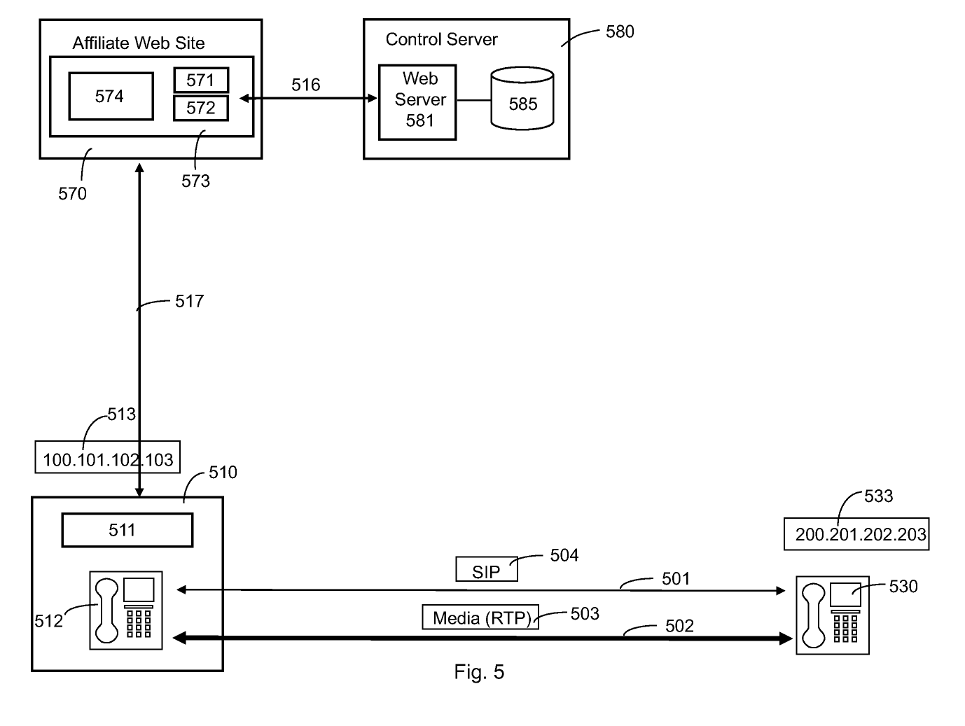

FIG. 5 shows an example of an affiliated website 570 that facilitates the establishment of a SIP communication according to one implementation. A Control Server 580, which contains a web server 581 and a database 585, provides links 571 and 572, which are displayed on a web page 573 of affiliated website 570, which also displays content 574. In FIG. 5 element 533 represents the IP address used by the device 530.

The Control Server 580 can transmit links 571 and 572 to the affiliated website so that the links are displayed on web page 573 when the page is displayed in browser 511 on device 510. Alternatively, the Control Server 580 can transmit links 571 and 572 directly to browser 511 when it downloads web page 573.

To display links 571 and 572, Control Server 580 can supply a code to the affiliated website 570, for example using the JavaScript language, which is added to web page 573, such that when the page is displayed on browser 511, the browser 511 also displays links 571 and 572, either because links 571 and 572 are transmitted directly from Control Server 580 to browser 511, or because links 571 and 572 are transmitted from Control Server 580 to affiliated website 570, which then transmits them to browser 511.

Affiliated website 570 may be, for example, a network node consisting of a web server connected to the Internet that displays web pages, including web page 573.

Control Server 580 may be composed of a single server or of a plurality of servers connected in a network through a local network, or the various servers can communicate with one another through the Internet network.

FIG. 5 shows a series of arrows 516, 517, 501 and 502 that link several device network nodes 570, 580, 510, 530. These arrows represent communications that may be communications in a local data network or communications through a data network that includes numerous routers, such as for example communications through the Internet network. The several devices can communicate with one another using different protocols, such as for example IPv4 or IPv6, although IPv4 type addresses are used in the figures to simplify the explanation.

Device 510 or network node 510 provides a network card that uses IP address 513, which may be, for example, the IPv4 100.101.102.103 type address. Device 510 also provides a browser or web browser 511 and an IP telephone 512 that may use, for example, the SIP protocol and called in this invention below SIP User Agent 512.

SIP User Agent 512 may be a software telephone or “softphone” or may also be hardware with a SIP telephone providing its own network interface and which is connected to device 510 to enable equipment 510 to establish communications using the SIP protocol. For simplicity, FIG. 5 shows SIP User Agent 512 within equipment 510 and using the same IP address as equipment 510.

When device 510 accesses the web page 573 of affiliated website 570 through a web browser or browser 511, it downloads web page 573 through the http protocol using the communication indicated by arrow 517.

When browser 511 displays the web page 573, it also displays links 571 and 572. As explained previously, these links can be transmitted to the browser from the affiliated website 570 or from Control Server 580.

Links 571 and 572 can contain first visible information, for example, an image and/or a text with an advertisement, and second information containing a SIP URI.

The SIP URI associated with link 571 is a SIP URI that allows communicating with SIP User Agent 530, which is an IP telephone that uses the SIP protocol and has an associated SIP URI contained in link 571.

The SIP URI allowing establishing a communication with SIP User Agent 530 using the SIP protocol can take the following values, as for example:

sip:bob@mediapatents.com
sip:bob@200.201.202.203

This information has been previously transmitted to the Control Server 580, in order to enable Control Server 580 to associate the SIP URI of User Agent 530 with link 571. For example, the owner of User Agent 530 has accessed a web page from web server 581 from a browser (that is not shown in FIG. 5) and has recorded its data and input the information of an advertisement or an advertising link.

The advertising link may comprise text and/or images about products or services that SIP User Agent 530 owner wishes to sell, and is also associated with SIP URI “sip:bob@mediapatents.com”. Control Server 580 can create link 571 from this information, which may comprise text and graphics and has an associated SIP URI allowing establishing communications with SIP User Agent 530.

This link 571 is displayed in browser 511 together with web page 573. Browser 511 can display link 571 as text and/or images form. If the browser's user is interested in the products or services advertised in link 571, he or she can activate the link and device 510 establishes a SIP communication between SIP User Agent 512 and SIP

User Agent 530 so that an individual, for example, a seller, handles the call received at SIP User Agent 530 and reports to the user of equipment 510 about the products or services advertised on link 571.

This communication is indicated through lines 501 and 502 that transmit, for example, IP packets transporting IP messages 504 and RTP packets 503, respectively.

Control Server 580 can associate a SIP URI with links 571 and 572 of web page 573 in several ways. A first way is to use an html language label or tag called a <meta> tag. The label makes it possible to add information called “metadata,” to any element of web page 573, for example allowing adding information with the SIP URI to links 571 or 572.

A second way of associating a SIP URI with a link, for example link 571, is through a JavaScript code that is executed when a certain event occurs on the link. For example, web page 573 can include a code in JavaScript language that is executed when the link 571 is activated, and the JavaScript code may contain information about the SIP URI of User Agent 530 and may even contain a call to an API using SIP User Agent 512 to start a communication with SIP User Agent 530.

A third way is that the links 571 and 572 are SIP URI links and the browser is capable of initiating a SIP communication upon clicking on one of the links or calls another program that initiates the SIP communication.

FIG. 5 provides a clearer depiction of a single affiliated website 570 and a single User Agent 530 to answer the calls originated upon activating link 571. Nevertheless, the system can preferably operate with a plurality of affiliated websites, a plurality of links generating communications through the SIP protocol and a plurality of SIP User Agents to handle the calls generated upon activating the links.

In FIG. 5 the communication between the two SIP User Agents is established directly without using a SIP Proxy.

However, browsers are programs that use the http protocol and, in principle, are not suitable for using the SIP protocol activated on links containing SIP URI type addresses. The browser functionality can be expanded in various ways in order to achieve this.

A first way of expanding the browser functionally so that it can establish SIP communications is through a “plug-in.” A plug-in is software that is installed on the device 510 to expand the browsers functionally.

A second way of enabling browser 511 to establish communications using the SIP protocol is through use of Active X type objects or Java applets that may be included in web page 573.

A third way of enabling use of the SIP protocol in browser 511 is by registering the SIP protocol as an operating system service in device 510, as described, for example, in U.S. Pat. No. 7,376,129.

By any of these methods browser 511 will be capable of establishing SIP communications by activating a link containing a SIP URI and can establish communications utilizing the SIP protocol, for example, SIP User Agent 512.

Nevertheless, in order for affiliated website 570 to be remunerated for the clicks that the users make when downloading web page 573, it is necessary for the Control Server 580 to detect the clicks on links 571 or 572 that establish SIP communications.

A problem to be solved is that Control Server 580 must detect when links 571 or 572 are displayed in the browser of device 510 and also detect when these links are activated and communications are established using the SIP protocol.

The tracking of links using the http protocol is known as previously discussed. Control Server 580 can detect that links 571 or 572 are displayed in browser 511, for example, by using a solution explained in U.S. Pat. No. 5,948,061, that is to say, by transmitting the parts of web page 573 containing links 571 or 572 from its own web server 581. In this way, every time that a browser accesses web page 573, the browser also establishes a communication with the web server 581 and obtains links 571 or 572 from the web server 581 using the http protocol.

However, this system does not allow Control Server 580 to detect when links 571 and 572 are activated, inasmuch as upon activating these links the browser establishes the SIP communication with User Agent 530 using the SIP protocol through communications 501 and 502, and Control Server 580 and web server 581 do not participate in the communications through the SIP protocol.

In the system of U.S. Pat. No. 5,948,061, when the user activates a link from a web page of an affiliated site, the user is directed to the web server, called the Advertiser Server, and from there is redirected to the advertiser's web page. This can be done because the entire function in this patent is based solely on the http protocol and there is a method of the http protocol that makes it possible to redirect an http request from one http URI to another. This kind of redirection used in the http protocol is described in Section “10.3 Redirection 3XX” of http protocol/1.1 described in specifications RFC 2616, R. Fielding, et. al., June 1999, currently available at the http://www.ietf.org/rfc/rfc2616.txt Internet address.

However, the method of redirecting the http protocol does not permit the establishment or the detection of communication through the SIP protocol in FIG. 5. That is to say, if the user of the browser activates link 571 and is directed to web server 581, the browser can be redirected to another page from server 581, but web server 581 cannot convert the http request that it receives from device 510 into a SIP communication between SIP User Agent 512 and SIP User Agent 530, because the redirecting of the http protocol does not permit a change in the protocol so the browser cannot use the SIP protocol to connect with another User Agent.

In FIG. 5, Control Server 580 does not participate in the SIP communication and cannot detect it.

This problem of detecting SIP communications from Control Server 580 also exists when SIP Proxies are used to establish the communications between the SIP User Agents 510 and 530.

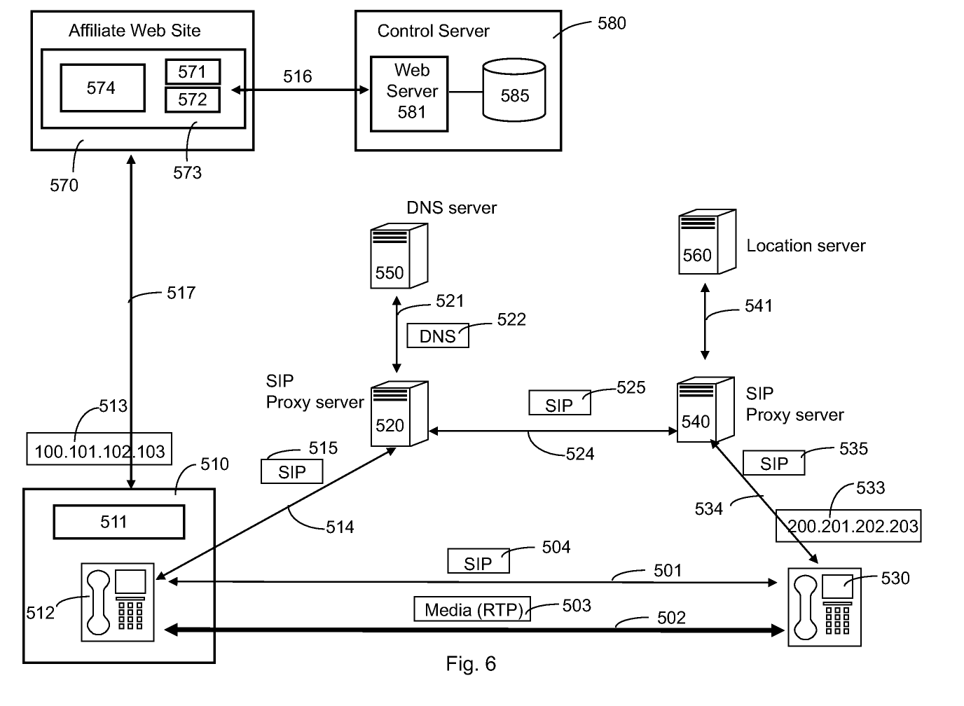

For example, in FIG. 6, the communication between SIP User Agent 512 and SIP User Agent 530 is established through SIP proxies 520 and 540 using communications 514, 524, 534 and 501 that transport SIP messages 515, 525, 535 and 504, and also using communication 502 using RTP 503 type packets, which transport the multimedia content directly between the SIP User Agents 512 and 530. However, Control Server 580 cannot detect the SIP communications that are generated when link 571 is activated in browser 511.

FIG. 6 also shows a DNS Server 550 that communicates 521 with SIP Proxy 520, exchanging messages 522 using the DNS protocol and a Location Server 560 that communicates 541 with SIP Proxy Server 540.

According to one implementation this problem is solved by enabling Control Server 580 to detect communications using the SIP protocol, and is established upon activating a link containing a SIP URI when this link has been created or supplied by Control Server 580 itself.

To accomplish this, Control Server 580 which supplies links 571 or 572 to browser 511, either directly or through affiliated website 570, includes in every SIP URI contained in each links 571 and 572 information identifying each link and each affiliated website.

Control Server 580 can use various headers or parameters in the SIP URI to include the identifying data for each link and each affiliated website in the SIP URI that the Control Server transmits to browser 511 directly or through web page 573.

The structure of the above-mentioned SIP URI is explained in Section “19.1.1 SIP and SIPS URI components” of RFC 3261. The general form of a SIP URI is as follows:

sip:user:password@host:port;uri-parameters?headers

Where:

“user” identifies a particular resource of the addressed device or host.

“Host” is the equipment or host providing the resource. The “host” may be, for example, an IPv4 or IPv6 type numeric IP address, or can also be a “FQDN” or “Fully-Qualified Domain Name”. A FQDN (Fully Qualified Domain Name) is a name that includes the name of the computer and the domain associated with that device. For example, in the example of a computer called “serv1” and a domain name of “bar.com,” the FQDN will be “serv1.bar.com”; similarly, a FQDN associated with serv1 could be “post.serv1.bar.com”.

“port” is the port number to which the SIP message is sent.

“uri-parameters” are parameters that contain information about the SIP message.

“headers” are headers or fields with information about the SIP message. The “20 Header Fields” Section of RFC 3261 describes the different headers that can be used. The names of the headers and their values are coded in pairs in the form, hname=hvalue.

The SIP URIs in the SIP messages can be delimited by the character “<” at the beginning, and the character “>” at the end to distinguish the parameters and headers of the SIP URI from the parameters and headers of the SIP messages.

There are different SIP headers that allows to include some identifying data of the link and the affiliated website in the SIP URI. For example, the SIP headers called “Call-info” and “Subject” may be used.

The “Call-Info” header is used to provide additional information upon establishing a SIP communication, for example an image of the person who is calling, a “vCard” or any other type of information. Its operation is explained in Section 20.9 of RFC 3261.

The “Subject” header provides information about the nature of a SIP call and its function is described in Section 20.36 of the RFC 3261.

Control Server 580 may include the link identifying data and the affiliated website in the SIP URI, by using the “Call-Info” and/ or “Subject” headers, for example.

For example, the SIP URI that the Control Server associates with link 571 may contain the following header identifying link 571 and affiliated website 570:

sip:bob@mediapatents.com?subject=link571 affiliate570

The Control Server can also create a SIP URI that includes a single numeric identifier that is associated with a certain link and affiliated website in database 585. For example, assuming that the identifier “123456789” is associated with link 571 and affiliated website 570 in the database, the Control Server can associate the following SIP URI with link 571:

sip:bob@mediapatents.com?subject=123456789

When SIP User Agent 512 establishes the SIP communication by sending the INVITE-type SIP message, it includes the information identifying each link and each affiliated website in the destination SIP URI.

Nonetheless, it is still necessary for the information to arrive at Control Server 580, which, as shown in FIG. 5, does not participate in the interchange of SIP messages.

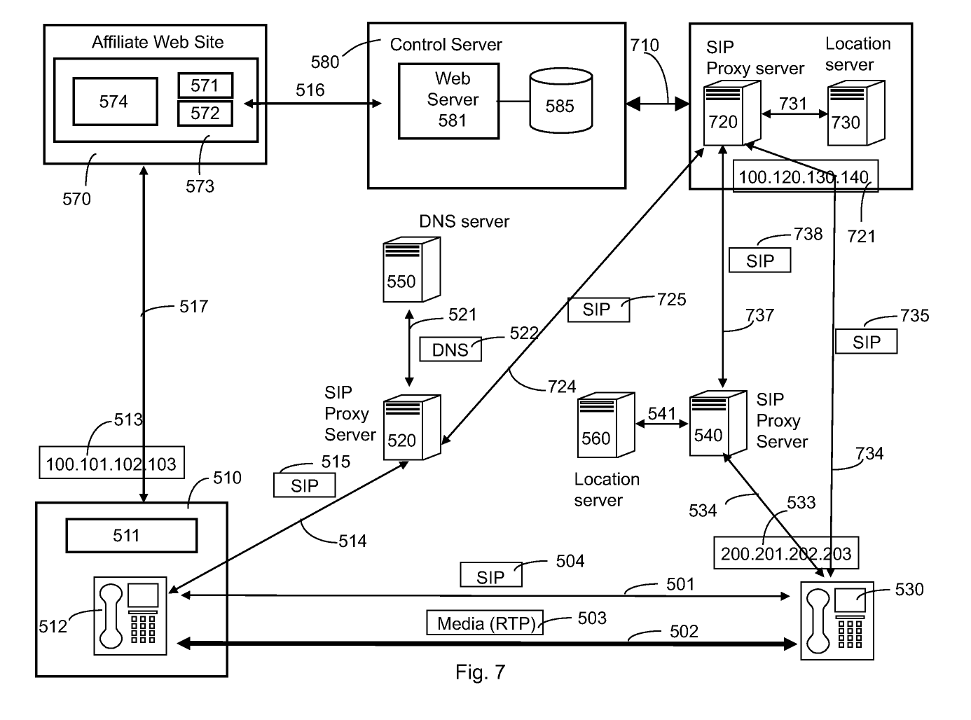

FIG. 7 shows an embodiment that solves this problem associating link 571 with a new AOR type SIP URI which uses a different domain than SIP Proxy 540, so that SIP messages arrive to a new SIP Proxy 720 which is configured to detect and retransmit to Control Server 580 the information included in the SIP URI identifying each link and each affiliated website.

In addition, in order for the SIP messages to reach SIP Proxy 720 addressed to the AOR-type SIP URI address that Control Server 580 has associated with the SIP User Agent 530, Control Server 580 transmits to a Location Server 730 server the “URI Contact” or the IP address of User Agent 530 that Location Server 730 associates with the AOR type SIP URI, for example, by sending a “REGISTER”-type SIP message, explained in the Section “10. Registration” of RFC 3261.

Accordingly, Control Server 580 includes in link 571 a SIP URI causing the SIP messages sent to User Agent 530 to pass through SIP Proxy 720.

For example, SIP Proxy 720 may use IP address 721 that has the value 100.120.130.140 and can have the associated “gsip.com” domain.

Control Server 580 associates with link 571 a SIP URI whose domain is gsip.com and the “user” identifies User Agent 530. For example, the SIP URI associated with link 571 can have the following value:

sip:useragent530@gsip.com?subject=12345678

Where “sip:useragent530@gsip.com” is the AOR type SIP URI that Control Server 580 has assigned to User Agent 530 and “123456789” is the above explained identifier that identifies link 571 and affiliated website 570 in database 585.

When User Agent 512 transmits an INVITE-type SIP message to establish a SIP communication with the SIP URI of the “gsip.com” domain, it sends the message to SIP Proxy 520, which queries DNS Server 550 to ascertain the IP address of the server offering the SIP services of “gsip.com” domain.

Server 550 responds that the IP address corresponding to the “gsip.com” domain is the IP address 100.120.130.140 used by SIP Proxy 720, and SIP Proxy 520 transmits the INVITE-type SIP message through communication 724 to SIP Proxy 720.

When SIP Proxy 720 receives the INVITE-type SIP message sent to the useragent530@gsip.com address, it queries, to Location Server 730 which is the “Contact” type SIP URI associated with the SIP URI, that is to say, which is the Contact URI or the IP address making it possible to transmit the SIP message to the User Agent 530 device, through communication 731.

Location Server 730 transmits the IP address used by User Agent 530 to SIP Proxy 720, that is to say the IP address 200.201.202.203 and SIP Proxy 720 transmits the INVITE message to User Agent 530 through communication 734.

In this way, SIP Proxy 720 receives SIP messages 725 sent to SIP User Agent 530 and in addition to retransmitting these SIP messages 735 to SIP User Agent 530, using communication 734, it detects that these messages include in the SIP URI some identifying information that identifies to SIP User Agent 530 making it possible to determine link 571 and affiliated website 570, and it retransmits this identifying data to Control Server 580 through the communication 710.

SIP Proxy 720 can retransmit to Control Server 580 the identifying data which identifies each link and each affiliated website that generates a SIP communication by using various communication protocols, such as for example, web Services, the SOAP (Simple Object Access Protocol) protocol, the TCP-IP protocol or even the SIP protocol itself, retransmitting message 725 to Control Server 580.

In this latter case, Control Server 580 receives message 725 which includes the SIP URI containing the data identifying link 571 and affiliated website 570.

Control Server 580 receives the identifying data, for example the identifier “123456789”, that identifies link 571 and affiliated website 570 which generated the SIP communication and stores the information in its database 585, in order to have the necessary information available to reward affiliated website 570 for the links activated on its web pages that generate calls to the advertisers' IP telephones.

Alternatively, the information that Control Server 580 sends to Location Server 730, so that SIP Proxy 720 transmits the SIP messages to User Agent 530, can include the SIP URI of SIP Proxy 540 instead for IP address 200.201.202.203. In this case the messages that the SIP Proxy 720 receives addressed to the SIP URI useragent530@gsip.com are transmitted 738 to SIP Proxy 540 through communication 737, and SIP Proxy 540 retransmits them to User Agent 530.

SIP User Agent 530 may be a User Agent that can operates with two different SIP URIs, for example, “sip:bob@mediapatents.com” and “sip:useragent530@gsip.com” or may be a User Agent that only uses the SIP URI assigned by Control Server 580: sip:useragent530@gsip.com.

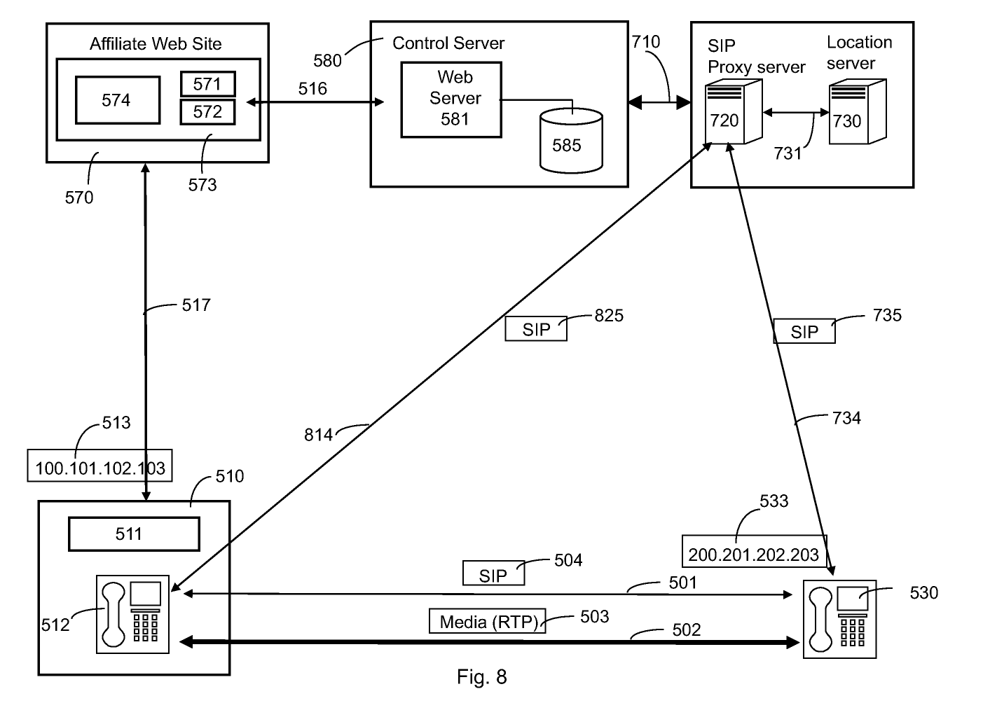

FIG. 8 shows another possible configuration in which User Agent 512 directly establishes a communication 814 with SIP Proxy 720 through which it transmits and receives SIP messages 825 to establish a communication with User Agent 530. Unlike FIG. 7, in the configuration of FIG. 8, SIP Proxies 520 and 540 are not used to establish a SIP communication.

The present invention also makes it possible to solve another problem with Internet advertising systems based on affiliated websites. This is the problem of fraudulent clicks.

This problem arises when the owner of web page 573 clicks on advertisements that are displayed on his or her web page to earn income.

Fraudulent clicks may be a greater problem than in advertising systems in web based affiliated sites, such as for example, the above explained prior art systems, inasmuch as each fraudulent click is converted into a call to an IP telephone and the user using SIP User Agent 530 must answer all the calls that he receives, because it is not possible to differentiate whether they have been generated through fraudulent clicks.

In one implementation the duration of the SIP communication established between SIP User Agents 512 and 530 is used as a datum to facilitate differentiating between calls generated by persons interested in the product or service offered on link 571, and calls generated through fraudulent clicks.

If the seller handling the call at User Agent 530 is talking for several minutes when he or she receives a call it is likely because he or she detects an interest in the person who called. Conversely, a call that lasts less than a few seconds (e.g., 3 seconds) can be made by a fraudulent click because, for example, the seller can detect that there is no one interested on the other end of the line and can end the call.

Nevertheless, as explained in FIG. 3, when User Agent 530 answers a call, for example by picking up the receiver of IP telephone 530, User Agent 530 sends a “200 OK” type SIP message and the following SIP messages exchanged between SIP User Agent 512 and SIP User Agent 530 do not pass through the SIP Proxy. Therefore, SIP Proxy 720 does not detect the length of the SIP calls and cannot use this data to distinguish whether the call has been generated by a fraudulent click.

In one implementation a property of the SIP protocol that requires all SIP messages to pass through a specific IP address, for example the IP address of a router or firewall is used to require all SIP messages of SIP calls received by SIP User Agent 530 through Proxy 720 compulsorily to pass through SIP Proxy 720 so that SIP Proxy 720 can measure the duration of the calls and thereby detect fraudulent clicks.

In this way SIP Proxy 720 receives “ACK” and “BYE” type SIP messages and can measure the length of the calls.

In one implementation SIP Proxy 720 can send a copy of all or some of the SIP messages that it receives to Control Server 580 and the length of the SIP communications can be measured by Control Server 580 to detect fraudulent clicks.

Control Server 580 and SIP Proxy 720 may exchange information about the SIP messages that have generated fraudulent clicks and can store this information. For example, they can store the IP address used in the browser where a fraudulent click has been generated, and can thereby filter SIP communications that are established in relation to the data transporting the SIP messages, for example by filtering the calls received by User Agent 530 to avoid calls generated from a device from which fraudulent clicks have previously been generated.

In one implementation headers called “Record-Route” and “Route” are used to require all the SIP messages from a SIP communication between SIP User Agents 512 and 530 to pass through SIP Proxy 720.

The Record-Route header is explained in section 20.30 of RFC 3261 and is inserted into Request type SIP messages, such as for example the INVITE message, to force all future Request type messages to pass through a certain Internet address.

For example, the following line contains a Record-Route type header requiring the following request-type SIP messages from a SIP communication to pass through the IP address 100.120.130.140 of SIP Proxy 720:

### Record-Route: <sip:100.120.130.140;Ir>

The IP address of the Record-Route header can be indicated in numeric form, through an IPv4 or IPv6 address, or even through a FQDN.

In FIG. 7, the line can be inserted into SIP messages 735 that transmit SIP Proxy 720 to SIP User Agent 530. IP address 100.120.130.140 is the IP address 721 used by SIP Proxy 720.

For example, SIP Proxy 720 may include this line in the INVITE-type SIP message transmitted by SIP User Agent 512 to SIP User Agent 530 in order to begin the communication.

When SIP User Agent 530 receives an invite-type SIP message with the Record-Route header: <sip:100.120.130.140;Ir>” it includes the same line with the same header in the “180 Ringing” and “200 OK” type SIP messages transmitted through SIP Proxy 720.

When SIP User Agent 512 receives the SIP message “200 OK,” it sends an ACK-type SIP message that is transmitted between SIP User Agent 512 and SIP User Agent 530, passing through the IP address 100.120.130.140. To accomplish this, SIP User Agent 512 includes a line with a Route header in the ACK-type SIP message. For example, the following line can be added:

### Route: <sip:100.120.130.140;Ir>

The “Route” header is explained in Section 20.34 of RFC 3261 and is used to make a Request type SIP message to be transmitted through a list of IP addresses.

Upon including the line with the Route header into the ACK type message transmitted by SIP User Agent 512, the SIP message will not be transmitted directly from SIP User Agent 512 to SIP User Agent 530, as occurred in FIG. 3, but rather it will be transmitted via the IP address of SIP Proxy 720.

When one of the two SIP User Agents finishes the SIP communication by sending a “BYE”-type SIP message, the message will also include a Route header for passing through IP address 100.120.130.140, and in this way SIP Proxy 720 can measure the time transpired between the ACK” and “BYE” messages. This time indicates the length of the call established through the SIP protocol.

As explained previously, SIP Proxy 720 may be configured to transmit a copy of all SIP messages received to Control Server 580, thus enabling Control Server 580 to detect fraudulent clicks.

In one implementation Control Server 580 stores all the information about the calls that have been generated upon activating link 571 in database 585.

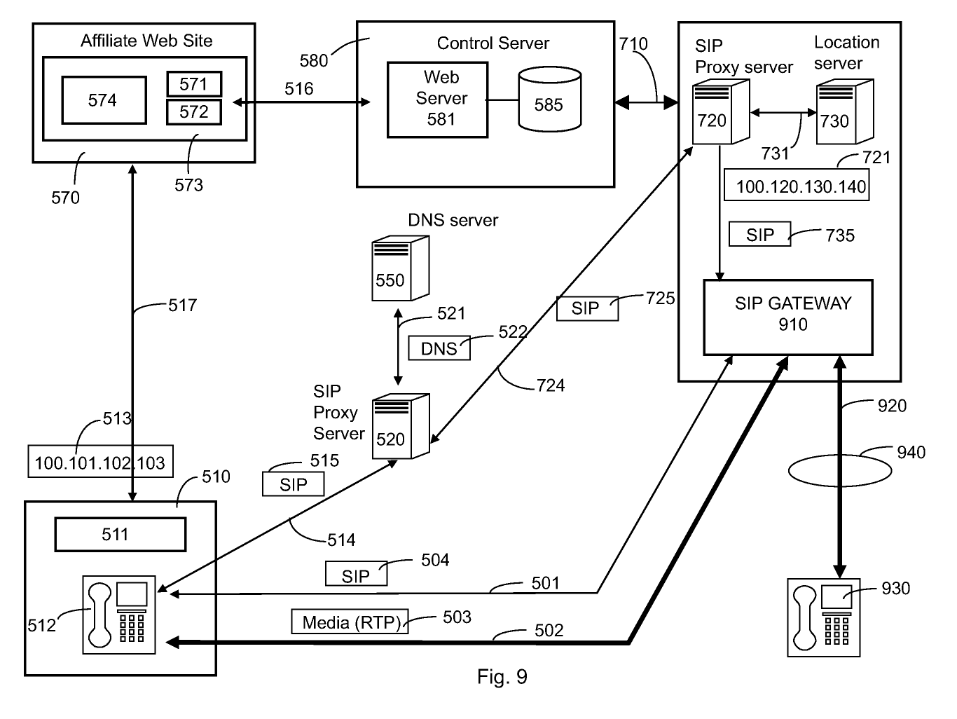

FIG. 9 shows an embodiment that uses a SIP Gateway 910 to transform the SIP communications established by SIP User Agent 512 into a telephone communication via a conventional telephone 930.

Telephone 930 may be, for example, a conventional mobile phone using cellular mobile technology, such as for example GPS or 3G, or may be an analogue telephone connected to a PSTN network. Data network 940 represents a telephony network that may be, for example, a GPS or 3G mobile telephony network or may be also, for example, a PSTN (“Public Switch Telephone Network”).

In one implementation SIP Gateway 910, which communicates with telephone 930 through communication 920 through telephone network 940 is used to convert the SIP communication established by SIP User Agent 512 into a conventional telephone communication, for example using a PSTN network.

A SIP Gateway is an application that interconnects data network device using the SIP protocol, with equipment from another data network that uses a different protocol. From the point of view of the SIP protocol, a SIP Gateway is a special type of SIP User Agent that communicates using a certain protocol instead of communicating with a person through headphones and a microphone.

In FIG. 9, Control Server 580 associates a SIP URI with telephone 930 in link 571, for example the following SIP URI:

sip:telephone930@gsip.com?subject=123456789”

When link 571 is activated in browser 511, device 510 begins a SIP communication addressed to the SIP URI.

When SIP Proxy Server 720 receives the INVITE-type SIP message sent by SIP User Agent 512 addressed to the SIP URI, it resends it to SIP Gateway 910, which uses a second communication protocol to establish a communication with telephone 930 using the second communications protocol.

The telephone number used by telephone 930 has been previously introduced to Control Server 580 by the user of telephone 930, when has sent the text and/or the images wanted to appear in advertising link 571 to Control Server 580, by using a web page, for example. Control Server 580 transmitted the information to Location Server 730 and to SIP Gateway 910.

In this way, the system can also be used by advertisers that do not have SIP telephones, such as SIP User Agent 530, and who wish to receive calls on conventional telephones, such as telephone 930, which are generated when advertising links 571 are activated.

What is claimed is:

1. A method of establishing an SIP communication between a first network device and a second network device, the first network device comprising a web browser and a first IP telephone, the second network device comprising a second IP telephone, the method comprising:
activating from the browser an advertising link on a webpage, the advertising link comprising identifying information of the advertising link, identifying information of the website hosting the advertising link and information containing a SIP URI associated with the second IP telephone; and
the first network device establishing a SIP communication between the first IP telephone and the second IP telephone using the SIP URI of the second IP telephone.

2. A method according to claim 1, wherein the advertising link comprises text and/or images about products and/or services of an entity associated with the second IP telephone.

3. A method according to claim 1, wherein the browser establishes the SIP communication between the first IP telephone and the second IP telephone by use of a plug-in installed on the first network device.

4. A method according to claim 1, wherein the webpage comprises Active X type objects and the browser establishes the SIP communication between the first IP telephone and the second IP telephone through the use of the Active X type objects.

5. A method according to claim 1, wherein the webpage comprises Java applets and the browser establishes the SIP communication between the first IP telephone and the second IP telephone through the use of the Java applets.

6. A method according to claim 1, further comprising registering the SIP protocol as an operating system service in the first network device prior to establishing the SIP communication between the first IP telephone and the second IP telephone.

7. A method according to claim 1, wherein the identifying information of the advertising link and the identifying information of the website hosting the advertising link is included in the SIP URI.

8. A method according to claim 7, wherein the identifying information of the advertising link and the identifying information of the website hosting the advertising link is included in the “Call-Info” and/or “Subject” headers of the SIP URI.

9. A method according to claim 1, wherein the advertising link is generated by a control server that stores in a database the identifying information of the advertising link, the identifying information of the website hosting the advertising link and the information containing the SIP URI associated with the second IP telephone.

10. A method according to claim 9, wherein the SIP communication between the first IP telephone and the second IP telephone is established through a SIP proxy that communicates with the second IP telephone and the control server, the SIP proxy using the SIP URI to identify the second IP telephone and to establish the SIP communication between the first IP telephone and the second IP telephone, the SIP proxy transmitting to the control server the identifying information of the advertising link and the identifying information of the website hosting the advertising link upon the SIP communication between the first IP telephone and the second IP telephone being established.

11. A method according to claim 1, wherein the advertising link is generated by a control server that stores in a database the identifying information of the advertising link, the identifying information of the website hosting the advertising link and the information containing the SIP URI associated with the second IP telephone, the control server storing a single numeric identifier that identifies the identifying information of the advertising link, the identifying information of the website hosting the advertising link and the information containing the SIP URI associated with the second IP telephone.

12. A method according to claim 11, wherein the SIP communication between the first IP telephone and the second IP telephone is established through a SIP proxy that communicates with the second IP telephone and the control server, the SIP proxy using the SIP URI to identify the second IP telephone and to establish the SIP communication between the first and second IP telephones, the SIP proxy transmitting to the control server the single numeric identifier upon the SIP communication between the first IP telephone and the second IP telephone being established.

13. A method according to claim 1, wherein the SIP communication between the first IP telephone and the second IP telephone is established through a SIP proxy, the SIP proxy using the SIP URI to identify the second IP telephone and to establish the SIP communication between the first and second IP telephones, all SIP messages exchanged during the SIP communication passing through the SIP proxy.

14. A method according to claim 13, wherein the SIP proxy tracks the duration of the SIP communication by use of the SIP messages.

15. A method according to claim 10, wherein all SIP messages exchanged during the SIP communication pass through the SIP proxy.

16. A method according to claim 15, wherein the SIP proxy determines the duration of the SIP communication by use of the SIP messages.

17. A method according to claim 16, wherein the SIP proxy transmits to the control server at least some of the SIP messages sufficient for the control server to determine the duration of the SIP communication.

18. A method according to claim 1, wherein the second IP telephone is a SIP gateway.
